(19) United States
(12) Patent Application Publication
(10) Pub. No.: US 2020/0066176 A1
(43) Pub. Date: Feb. 27, 2020

(54) METHOD OF EDUCATION AND ELECTRONIC DEVICE

(71) Applicant: National Taiwan Normal University, Taipei City (TW)

(72) Inventors: Wei-Yen WANG, Taipei City (TW); Jon-Chao HONG, Taipei City (TW); Chi-Ruei TSAI, Taipei City (TW)

(73) Assignee: National Taiwan Normal University, Taipei City (TW)

(21) Appl. No.: 16/231,143

(22) Filed: Dec. 21, 2018

(30) Foreign Application Priority Data
Aug. 23, 2018 (TW) 107129402

(51) Int. Cl. G09B 7/08; G09B 7/04

(52) U.S. Cl. CPC G09B 7/08; G09B 7/04

(57) ABSTRACT

A method of education is to be implemented by a processing unit of an electronic device which includes an input unit and an output unit, and the processing unit is capable of accessing a lexical database that includes a plurality of terms. The method includes: controlling the output unit to output a question; determining whether a user answer matches a correct answer to the question; when the user answer does not match the correct answer, determining whether the user answer corresponds to one of the terms in the lexical database; and when the user answer corresponds to one of the terms, controlling the output unit to output a definition of said one of the terms.

### CROSS-REFERENCE TO RELATED APPLICATION

This application claims priority to Taiwanese Patent Application No. 107129402 filed on Aug. 23, 2018.

### FIELD

The disclosure relates to a method of education, and an electronic device for implementing the method of education.

### BACKGROUND

Generally, a conventional learning system or method only lets a user know if his/her answer to a question is correct or not, and would not provide further information on an incorrect answer.

### SUMMARY

Therefore, an object of the disclosure is to provide an education method capable of interacting with a user.

According to one aspect of the disclosure, a method of education is provided. The method is to be implemented by a processing unit of an electronic device. The electronic device further includes an input unit and an output unit. The processing unit is capable of accessing a lexical database that includes a plurality of terms. The method includes:

controlling the output unit to output a question;

in response to receipt of a user answer from the input unit, determining whether the user answer matches a correct answer to the question;

when it is determined that the user answer does not match the correct answer, determining whether the user answer corresponds to one of the terms in the lexical database; and when it is determined that the user answer corresponds to one of the terms, controlling the output unit to output a definition of said one of the terms.

### BRIEF DESCRIPTION OF THE DRAWINGS

Other features and advantages of the disclosure will become apparent in the following detailed description of the embodiments with reference to the accompanying drawings, of which:

FIG. 1 is a schematic block diagram of an electronic device for implementing a method of education according to one embodiment of this disclosure;

FIG. 2 is a flow chart illustrating an extended education procedure of the method of education according to one embodiment of this disclosure; and

FIG. 3 is a flow chart of an error correction procedure of the method of education according to one embodiment of this disclosure.

### DETAILED DESCRIPTION

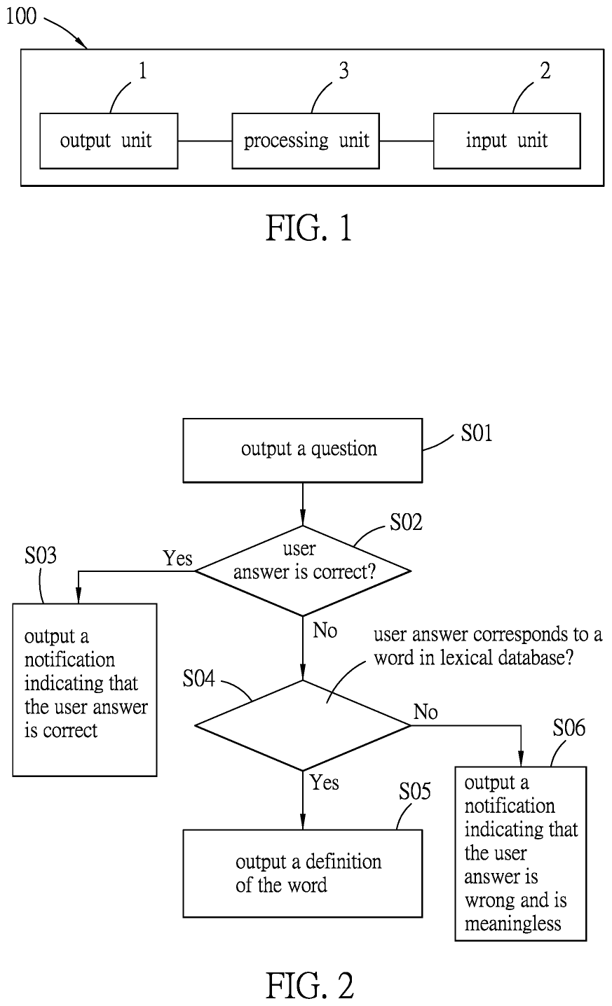

Referring to FIG. 1, an electronic device 100 is to implement a method of education according to one embodiment of the present disclosure. The electronic device 100 includes an output unit 1, an input unit 2 and a processing unit 3. The processing unit 3 is electrically connected to the input unit 2 and the output unit 1, and is capable of accessing a lexical database including a plurality of terms. For example, the lexical database is stored in a cloud server including a storage medium, or is stored in a non-transitory memory of the electronic device 100.

The electronic device 100 is, for example, a mobile phone (e.g., a smartphone) in this embodiment, and can be, for example, a personal digital assistant (PDA), a tablet computer or a smart watch in other embodiments of the present disclosure. The output unit 1 includes, for example, a display and a speaker. The input unit 2 includes, but not limited to, a touch pad and a microphone as an example. The term “processing unit” as used throughout the specification may refer to any device or portion of a device that processes electronic data from registers and/or memory to transform that electronic data into other electronic data. For example, the processing unit 3 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), or the like.

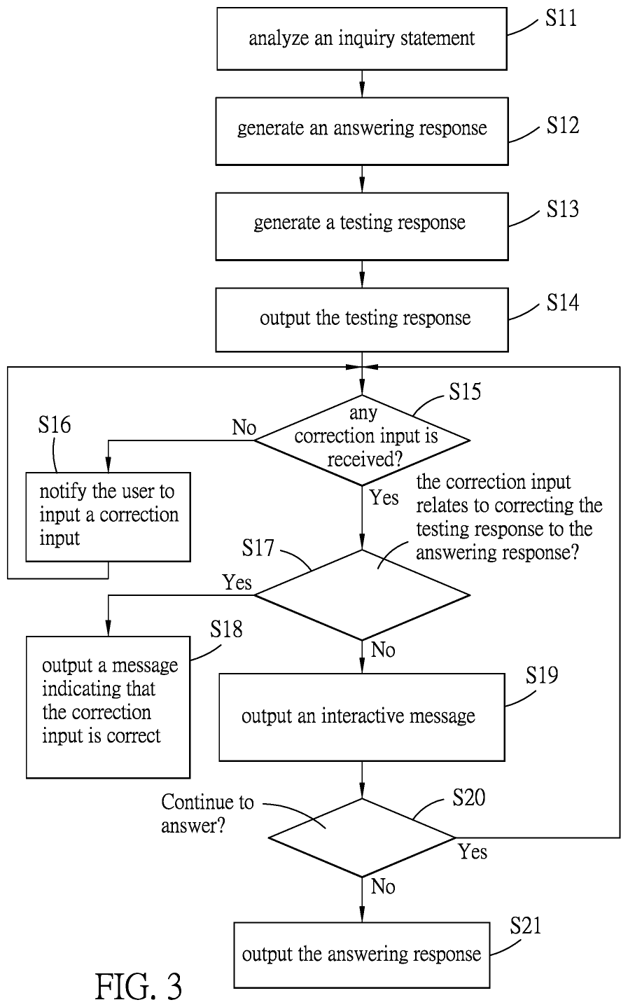

The method of education includes an extended education procedure (see FIG. 2) and an error correction procedure (see FIG. 3). As shown in FIG. 2, the extended education procedure includes steps S01 to S06. In step S01, the processing unit 3 controls the output unit 1 to output a question. For example, the question asks in English “How to say honey in Chinese?” and a correct answer to this question is “ [symbol] [symbol] ”, which means “honey” in Chinese.

In step S02, in response to receipt of a user answer from the input unit 2, the processing unit 3 determines whether the user answer matches the correct answer to the question. When it is determined that the user answer is correct (matches the correct answer), the flow of the extended education procedure goes to step S03; otherwise, the flow of the extended education procedure goes to step S04.

In step S03, the processing unit 3 controls the output unit 1 to output a notification indicating that the user answer matches the correct answer to the question. For example, the display of the output unit 1 is controlled to display “Correct Answer!” In step S04, the processing unit 3 accesses the lexical database and determines whether the (wrong) user answer corresponds to one of the terms in the lexical database. When it is determined that the user answer corresponds to one of the terms, the flow of the extended education procedure goes to step S05; otherwise, the flow of the extended education procedure goes to step S06.

In step S05, the processing unit 3 controls the output unit 1 to output a definition of said one of the terms. Continuing with the previously described example, when the user answer to the question of “How to say honey in Chinese?” is “ [symbol] ”, which means “bee” in Chinese, the processing unit 3 determines, in step S02, that the user answer does not match the correct answer, determines, in step S04, that the (wrong) user answer corresponds to one of the terms in the lexical database, and controls, in step S05, the output unit 1 to output the definition of the (wrong) user answer that “‘ [symbol] ’ is bee”. In some embodiments, the processing unit 3 controls the output unit 1 to further output the correct answer to the question.

In step S06, the processing unit 3 controls the output unit 1 to output a notification indicating that the user answer is wrong and is meaningless and not found in the lexical database. For example, the display of the output unit 1 displays a message “I don't understand what you said.”

In other embodiments, when it is determined that the user answer does not correspond to any term in the lexical database, the flow of the extended education procedure goes to an alternative step of controlling, by the processing unit 3, the output unit 1 to output the correct answer to the question. For example, the display of the output unit 1 displays “‘ [symbol] ’ is the Chinese equivalent of ‘honey’.”

It should be noted that the output unit 1 outputs the question, the notification and the definition of one of the terms in the lexical database through the display and/or the speaker thereof, and the touch pad and/or the microphone of the input unit 2 receives the user answer. For example, a user may operate the touch pad of the input unit 2 to input the user answer via a virtual keyboard, or operate the touch pad of the input unit 2 to enter a handwriting input as the user answer.

The present disclosure is not limited to these examples.

By virtue of the extended education procedure that provides the definition of the wrong user answer, as long as the content of the user answer is meaningful (i.e., corresponding to one of the terms in the lexical database), the user can learn the definition of the wrong user answer. The correct answer to the question can also be provided to the user when the user answer is incorrect, and thus the learning effect can be improved.

Now referring to FIGS. 1 and 3, the error correction procedure of the method of education will be described. In step S11, in response to receipt of an inquiry statement from a user through the input unit 2, the processing unit 3 analyzes the inquiry statement using a natural-language interpretation technique. For example, the inquiry statement is “How is the weather tomorrow?”

In step S12, the processing unit 3 generates an answering response to the inquiry statement in a form of natural language using a natural-language generation technique. For example, continuing with the example described in step S11, the answering response is “The weather is fine tomorrow.”

Subsequent to step S12, in step S13, the processing unit 3 generates a testing response that possesses grammar error or a spelling error, or both, based on the answering response according to a predetermined principle. For example, the testing response may be “The weather fine tomorrow.” which possesses a grammar error, or “The weather is fine tomorrow.” which possesses a spelling error.

In step S14, the processing unit 3 controls the output unit 1 to output the testing response.

In step S15, the processing unit 3 determines whether any correction input is received within a predetermined time period. When affirmative, step S17 is performed; otherwise, step S16 is performed.

In step S16, the processing unit 3 controls the output unit 1 to output a notification message for notifying the user to input a correction input. For example, the notification message is displayed on the display of the output unit 1 “Am I right?” After step S16, step S15 is repeated.

In step S17, in response to receipt of a correction input directed to the testing response from the input unit 2, the processing unit 3 determines whether the correction input relates to correcting the testing response to the answering response. When it is determined that the correction input relates to correcting the testing response to the answering response, the flow of the error correction procedure goes to step S18; otherwise, the flow of the error correction procedure goes to step S19. In the previous example of the testing response being “The weather fine tomorrow.”, when a correction input of “Do you mean ‘The weather is fine tomorrow’?” is received, the processing unit 3 determines that the correction input relates to correcting the testing response (The weather fine tomorrow) to the answering response (The weather is fine tomorrow). In the example of the testing response being “The weather is fine tomorrow.”, when a correction input of correcting “weather” to “weather” is received from the touch pad of the input unit 2, the processing unit 3 determines that the correction input relates to correcting the testing response to the answering response.

In step S18, the processing unit 3 controls the output unit 1 to output a message indicating that the correction input is correct. For example, the display of the output unit 1 displays “You are right!”

In step S19, when the correction input does not relate to correcting the testing response to the answering response, the processing unit 3 controls the output unit 1 to output an interactive message. For example, the display of the output unit 1 displays the interactive message as having two options of “Do you want to know the correct answer?” and “Continue to answer” to be selected by the user, and the input unit 2 transmits, in response to user selection of one of the options, an instruction indicating which option is selected to the processing unit 3.

In step S20, in response to receipt of the instruction, the processing unit 3 determines which option is selected based on the instruction. When it is determined that the instruction for outputting the answering response (i.e., the instruction indicates that the option “Do you want to know the correct answer?” is selected) is received, the flow of the error correction procedure goes to step S21. When it is determined that the instruction indicating that the option “Continue to answer” is selected, step S15 is performed again.

In step S21, in response to receipt of the instruction from the input unit 2 for outputting the answering response, the processing unit 3 controls the output unit 1 to output the answering response.

By virtue of the error correction procedure of the education method, the user can learn from the testing response by correcting a grammar error and/or a spelling error in the testing response.

To sum up, the method of education of the present disclosure is to determine whether the wrong user answer corresponds to one of the terms in the lexical database, and to output the definition of the wrong user answer or to output the correct answer to the question. In this way, as long as the content of the user answer is meaningful, the user can continue to learn from using the method of education. Additionally, the user can learn from the testing response generated by the processing unit 3 using the natural-language generation technique by correcting a grammar error and/or a spelling error in the testing response to interact with the electronic device 100, so that learning effect can be improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of education to be implemented by a processing unit of an electronic device, the electronic device further including an output unit and an input unit, the processing unit capable of accessing a lexical database that includes a plurality of terms, the method comprising:
controlling the output unit to output a question;
in response to receipt of a user answer from the input unit, determining whether the user answer matches a correct answer to the question;
when it is determined that the user answer does not match the correct answer, determining whether the user answer corresponds to one of the terms in the lexical database; and
when it is determined that the user answer corresponds to one of the terms, controlling the output unit to output a definition of said one of the terms.

2. The method as claimed in claim 1, further comprising:
in response to receipt of an inquiry statement from the input unit, analyzing the inquiry statement using a natural-language interpretation technique;
generating an answering response to the inquiry statement in a form of natural language using a natural-language generation technique;
generating a testing response that possesses one of grammar error and a spelling error based on the answering response according to a predetermined principle; and
controlling the output unit to output the testing response.

3. The method as claimed in claim 2, further comprising:
in response to receipt of a correction input directed to the testing response from the input unit, determining whether the correction input relates to correcting the testing response to the answering response; and
when it is determined that the correction input does not relate to correcting the testing response to the answering response, in response to receipt by the input unit of an instruction for outputting the answering response, controlling the output unit to output the answering response.

4. The method as claimed in claim 3, further comprising:
when not receiving any correction input from the input unit for a predetermined time period, controlling the output unit to output a notification message for notifying the user to input a correction input.

5. An electronic device, comprising:
an output unit;
an input unit; and
a processing unit electrically connected to said input unit and said output unit, and configured to access a lexical database that includes a plurality of terms;
wherein said processing unit is further configured to:
control said output unit to output a question;
in response to receipt of a user answer from said input unit, determine whether the user answer matches a correct answers to the question;
when determining that the user answer does not match the correct answer, determine whether the user answer corresponds to one of the terms in the lexical database;
when determining that the user answer corresponds to one of the terms, control said output unit to output a definition of said one of the terms.

6. The electronic device as claimed claim 5, wherein said processing unit is further configured to:
in response to receipt of an inquiry statement from the input unit, analyze the inquiry statement using a natural-language interpretation technique;
generate an answering response to the inquiry statement in a form of natural language using a natural-language generation technique;
generate a testing response that possesses one of grammar error and spelling error based on the answering response according to a predetermined principle; and
control said output unit to output the testing response.

7. The electronic device as claimed in claim 6, wherein said processing unit is further configured to:
in response to receipt of a correction input directed to the testing response from the user by said input unit, determine whether the correction input relates to correcting the testing response to the answering response; and
when determining that the correction input does not relate to correcting the testing response to the answering response, in response to receipt by said input unit of an instruction for outputting the answering response, control said output unit to output the answering response.

8. The electronic device as claimed in claim 7, wherein said processing unit is further configured to, when not receiving any correction input from said input unit for a predetermined time period, control said output unit to output a notification message for guiding the user to input a correction input.
